(19) United States
(12) Patent Application Publication
(10) Pub. No.: US 2004/0052709 A1
(43) Pub. Date: Mar. 18, 2004

(54) Vapor evacuation device

(76) Inventor: Ernest L. Taylor, Baton Rouge, LA (US)

Correspondence Address: Roy, Kiesel, Keegan and DeNicola, 2355 Drusilla Lane (70809), P.O. Box 15928, Baton Rouge, LA, 70895-5928, US

(21) Appl. No.: 10/647,049

(22) Filed: Aug. 22, 2003

Related U.S. Application Data
(63) Continuation-in-part of application No. 10/288,216, filed on Nov. 5, 2002, now Pat. No. 6,616,418.
Application No. 10/288,216 is a continuation-in-part of application No. 10/087,326, filed on Mar. 1, 2002.

(51) Int. Cl. B08B 3/00

(52) U.S. Cl. 423/234; 422/168; 422/176; 134/123; 134/166 R

(57) ABSTRACT

According to the present invention, the vapor evacuation device comprises a mobile housing encasing at least one fluid line configured to draw vapors from a tank via an inlet, and to feed these vapors through solution. This process yields a relatively benign liquid solution together with vapors which can be drained and vented, respectively, when convenient to the operator.

This application is a continuation in part of U.S. application Ser. No. 10/288,216, filed on Nov. 5, 2002, which is a continuation in part of U.S. application Ser. No. 10/087,326, filed on Mar. 1, 2002, pending, which are both hereby incorporated by reference in their entirety.

### BACKGROUND OF THE INVENTION

The present invention relates to the evacuation of hazardous and/or harmful vapors from a vessel or tanker vehicle. These vapors are typically vented into the atmosphere where they can cause environmental problems, or stored in the tanker vehicle where they can pose a danger, especially if they are flammable and/or volatile. Alternately, large stationary systems can be used to filter and scrub the vapor content of a vessel; however, these generally employ complicated techniques, and are fixed in their physical location, severely limiting their usefulness.

The invention proposed in this application is mobile, as well as vastly simplified in use, permitting inexpensive and easy use on all harmful vapor-carrying vessels, while simultaneously improving the environment and alleviating safety concerns in storing and disposing of these vapors.

### OBJECTS OF THE INVENTION

One object of the invention is to provide a vapor evacuation device that can evacuate vapors from vapor-laden vessels.

Another object of this invention is to provide a vapor evacuation device which combines harmful vapors into an easily disposable and relatively benign liquid and/or gas.

Still another object of the invention is to provide a vapor evacuation device which is mobile and/or portable.

Other objects and advantages of this invention shall become apparent from the ensuing descriptions of the invention.

### SUMMARY OF THE INVENTION

According to the present invention, the vapor evacuation device comprises a mobile housing encasing at least one fluid line configured to draw vapors from a tank via an inlet, and to feed these vapors through solution. This process yields a relatively benign liquid solution together with vapors which can be drained and vented, respectively, when convenient to the operator.

### BRIEF DESCRIPTION OF THE DRAWINGS

The accompanying drawings illustrate an embodiment of this invention. However, it is to be understood that this embodiment is intended to be neither exhaustive, nor limiting of the invention. They are but examples of some of the forms in which the invention may be practiced.

FIG. 1 shows a diametrical longitudinal cross section of an exemplary embodiment of a mobile vapor evacuation device.

FIG. 2 shows an elevational view of a vapor evacuation device configured as part of a tanker truck.

FIG. 3 shows an elevational view of a vapor evacuation device configured as a standalone trailer and in use with a rail tanker car.

### DETAILED DESCRIPTION OF EXEMPLARY EMBODIMENTS

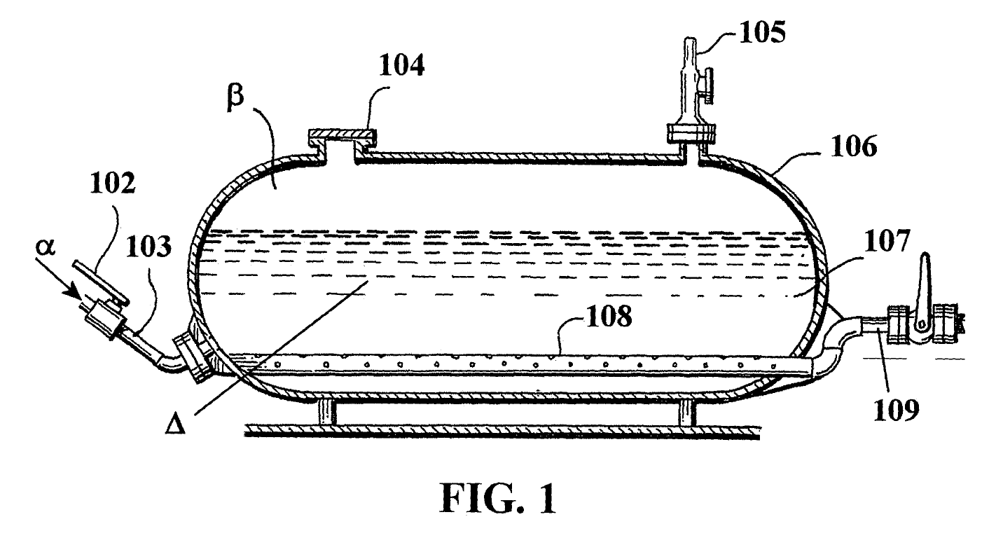

Without any intent to limit the scope of this invention, reference is made to the figures in describing the various embodiments of the invention. Referring to FIGS. 1 through 3, a mobile vapor evacuation system 100 is pictured, which is used to purify vapors evacuated from a vessel 101. Transport vessel 101, which can contain gaseous or liquid chemicals or other products, will often leave vaporous residue in vessel 101 when evacuated of its primary payload. It is desirable, for environmental and safety reasons, to evacuate and clean, or “scrub” this vaporous residue from vessel 101 using vapor evacuation system 100.

Vapor evacuation system 100 includes housing 106 which encloses the inner components of vapor evacuation system 100. Within housing 106 is fluid passageway 103, which can be any type of pipe or conduit capable of carrying fluids. Fluids can enter through first aperture 102, which can be a valve or fitting or simply the opening of the pipe or conduit that permits a fluid communication between vessel 101 and vapor evacuation system 100.

Downstream of first aperture 102 is second aperture 108 which provides the fluid communication between housing 106 and fluid passageway 103. This second aperture 108 can be a single exit port, or, as shown in FIG. 1, a series of perforations in fluid passageway 103.

Downstream from second aperture 108, vapor evacuation device 100 can have third aperture 109, which may, like first aperture 102, be a valve, fitting or the like. Third aperture 109 may be used for evacuating fluid, such as scrubbing solution A, which enters fluid passageway 103 and/or housing 106. Scrubbing solution A can be myriad different chemicals, such as caustic soda or the like. Scrubbing solution A can also be formulated to address a particular chemical concern or to achieve a desired result depending upon vapor evacuation device's 100 application.

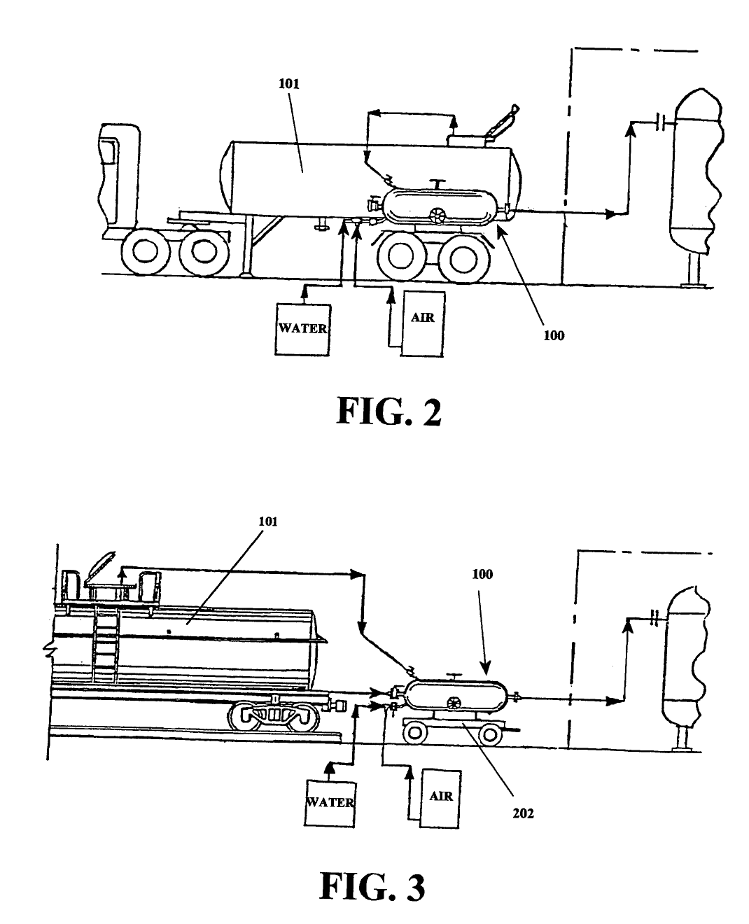

Vapor evacuation device 100 is mounted upon a mobile chassis 201, such as a wheeled chassis as in FIG. 3. It can also be on a self-propelled vehicle, such as a truck, as pictured in FIG. 2. Alternately, it can be mounted on skids, pontoons, tracks, treads or on a floating chassis, such as a boat.

Vapor evacuation device 100 will generally include atmospheric vent 105 which is used to release the pressure that builds within housing 106 as a result of operation of vapor evacuation device 100. Additionally, a drain can be placed at the bottom of housing 106 in order to more completely evacuate vapor evacuation device 100 of all fluids left behind after use.

It is also possible to have a sight glass installed in housing 106 so that the contents of vapor evacuation device 100 can be verified or inspected to ensure correct or desired operation. Further, a motor can be positioned in various locations along fluid passageway 103 in order to expedite the flow of fluid through vapor evacuation device 100.

In operation, one method of use is to first fill vapor evacuation device 100 with scrubbing solution Δ by connecting first aperture 102 to the scrubbing solution A source, such as a faucet, tank or other containing device. Third aperture 109, if present, will be closed to prevent the escape of scrubbing solution Δ from vapor evacuation device 100.

A user will then connect first aperture 102 to vessel 106, which has some internal pressure generally greater than that of the ambient atmospheric pressure outside of vapor evacuation device 100. This pressure variation arises as a result of the vaporous residue in vessel 101 being at a lower atmospheric pressure than the relative environment. Such differential in pressure causes a natural flow of vapors α into fluid passageway 103.

Housing 106 is filled with a scrubbing solution Δ. First aperture 102 may then be opened to permit fluid communication between vessel 101 and vapor evacuation device 100. Vapors α will proceed to flow into first aperture 102 and subsequently out of second aperture 108 into scrubbing solution Δ. Once vapors α flow through scrubbing solution Δ, a chemical reaction therein yields a more benign fluid and environmentally-sound vapors which can be released into the atmosphere without fear of contamination of the air.

Various substances may be added to scrubbing solution Δ within tank to achieve assorted results, such as odor control, neutralization and the like by adding selected chemicals through access door 104. Such chemicals may also be added via other valves previously mentioned, if desired or needed. Additionally, since vapors a will build over the course of recirculating, a pressure relief valve 105 can also be employed to prevent explosion, or enable the user to “bleed off” pressure as needed.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims.

The invention claimed is:

1. A vapor evacuation device for removing and scrubbing vapors from a vessel comprising:
A housing, configured to contain a scrubbing solution, substantially enclosing a fluid passageway having a first aperture configured to permit the introduction of a fluid into said fluid passageway from said vessel, said fluid passageway further comprising a second aperture positioned downstream from said first aperture, whereby fluid entering said passageway will flow from said first aperture toward said second aperture, said second aperture configured to provide fluid communication between said housing and said fluid passageway.

2. A vapor evacuation device according to claim 1 wherein said second aperture is a plurality of perforations in said fluid passageway through which fluid may flow into said housing.

3. A vapor evacuation device according to claim 2 further comprising a mobile chassis upon which said vapor evacuation device is mounted.

4. A vapor evacuation device according to claim 3 further comprising a sight glass configured to provide a view of the contents of said housing.

5. A vapor evacuation device according to claim 4 further comprising a pressure relief valve positioned in said housing through which excess vapors can be evacuated.

6. A vapor evacuation device according to claim 5 further comprising a drain positioned to permit liquid that may become trapped within said housing to drain therefrom.

7. A vapor evacuation device according to claim 6 wherein said mobile chassis comprises a frame and a plurality of wheels operatively connected thereto.

8. A vapor evacuation device according to claim 7 further comprising a motor operatively configured to draw said vapors from said vessel at an accelerated rate.

9. A vapor evacuation system comprising:
a. a mobile chassis;
b. a vessel mounted on said chassis; and
c. a vapor evacuation device as described in claim 1 mounted on said chassis for removing vapors from said vessel.

10. A vapor evacuation system comprising:
a. a buoyant base;
b. a vessel mounted on said chassis; and
c. a vapor evacuation device as described in claim 1 mounted on said chassis for removing vapors from said vessel.

11. A method of evacuating and scrubbing vapors from a vessel using a vapor evacuation device as described in claim 1, comprising: filling said housing with said scrubbing solution, connecting said first aperture to said vessel whereby said vapor will flow through said fluid passageway and through said second aperture into said scrubbing solution.

12. A method of evacuating vapors from a vessel according to claim 11 wherein said second aperture of said fluid connection is a series of perforations through which fluid and gas may escape.

13. A method of evacuating vapors from a vessel according to claim 12 further comprising a mobile chassis upon which said vapor evacuation device is mounted.

14. A vapor evacuation device for removing and scrubbing vapors from a vessel comprising:
A housing, configured to contain a scrubbing solution, substantially enclosing a fluid passageway having a first aperture configured to permit the introduction of a fluid into said fluid passageway from said vessel, said fluid passageway further comprising a third aperture positioned downstream from said first aperture, whereby fluid entering said passageway will flow from said first aperture toward said third aperture, said fluid passageway further comprising a second aperture configured to provide fluid communication between said housing and said fluid passageway.
